(19) United States
(12) Patent Application Publication
(10) Pub. No.: US 2010/0205970 A1
(43) Pub. Date: Aug. 19, 2010

(54) Systems, Methods, and Apparatus Providing a Secondary Fuel Nozzle Assembly

(75) Inventors: William Kirk Hessler, Lincoln University, PA (US); Richard Gene Lowe, Gray Court, SC (US); Predrag Popovic, Simpsonville, SC (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 12/388,855

(22) Filed: Feb. 19, 2009

(51) Int. Cl. F02C 7/22

(52) U.S. Cl. 60/734; 239/548

(57) ABSTRACT

Provided are systems, methods, and apparatus providing secondary fuel nozzle assemblies. For example, a secondary fuel nozzle assembly can include a central portion having a proximal end and distal end, and defining a central passage therethrough, which can include at least one coiled tube extending through the central passage from the proximal end to the distal end; a flange having at least one main secondary fuel orifice in fluid communication with the central passage at the proximal end and at least one pilot orifice in fluid communication with the at least one coiled tube at the proximal end; and a tip portion having a proximal end and distal end, and defining at least one passage therethrough, which can be in fluid communication with the distal end of the at least one coiled tube and at least one orifice formed in the distal end of the tip portion.

### FIELD OF THE INVENTION

This invention relates generally to combustors, and more specifically to systems, methods, and apparatus providing secondary fuel nozzle assemblies.

### BACKGROUND OF THE INVENTION

In an effort to reduce pollution from gas-powered turbines, governmental agencies have enacted numerous regulations requiring reductions in the amount of emissions, especially nitrogen oxide (NOx) and carbon monoxide (CO). Lower combustion emissions can be attributed to a more efficient combustion process, with specific regard to fuel injectors and nozzles. Early combustion systems utilized diffusion type nozzles that produce a diffusion flame, which is a nozzle that injects fuel and air separately and mixing occurs by diffusion in the flame zone. Diffusion type nozzles produce high emissions due to the fact that the fuel and air burn stoichiometrically at high temperature. An improvement over diffusion nozzles is the utilization of some form of premixing such that the fuel and air mix prior to combustion to form a homogeneous mixture that burns at a lower temperature than a diffusion type flame and produces lower NOx emissions. One example nozzle type that facilitates premixing is a secondary fuel nozzle, providing fuel delivery downstream in a combustion chamber.

A conventional secondary fuel nozzle assembly can be a multi-weld, multi-part, complex assembly. As a consequence the assembly typically includes multiple seals and multiple welds that create potential failure locations and leak paths. Excessive heat causes component expansion, which can compromise seals and welds as used in conventional secondary fuel nozzles.

Accordingly, there exists a need for systems, methods, and apparatus providing secondary fuel assemblies to avoid failures that can result from heat expansion.

### BRIEF DESCRIPTION OF THE INVENTION

Certain embodiments of the invention can provide systems, methods, and apparatus providing secondary fuel nozzle assemblies. According to one embodiment, a secondary fuel nozzle assembly is provided. The secondary fuel nozzle assembly can include a central portion having a proximal end and distal end, and defining a central passage therethrough. The central portion can include at least one coiled tube extending through the central passage from the proximal end to the distal end. The secondary fuel nozzle assembly can further include a flange having at least one main secondary fuel orifice in fluid communication with the central passage at the proximal end and at least one pilot orifice in fluid communication with the at least one coiled tube at the proximal end. The secondary fuel nozzle assembly can further include a tip portion having a proximal end and distal end, and defining at least one passage therethrough. The at least one passage can be in fluid communication with the distal end of the at least one coiled tube and at least one orifice formed in the distal end of the tip portion.

According to another embodiment, a gas turbine with a combustion chamber having at least one secondary fuel nozzle assembly is provided. The secondary fuel nozzle assembly of the gas turbine can include a central portion having a proximal end and distal end, and defining a central passage therethrough, and having at least one coiled tube extending through the central passage from the proximal end to the distal end. The secondary fuel nozzle assembly can also include a flange having at least one main secondary fuel orifice in fluid communication with the central passage at the proximal end and at least one pilot orifice in fluid communication with the at least one coiled tube at the proximal end. The secondary fuel nozzle assembly can further include a tip portion having a proximal end and distal end, and defining at least one passage therethough, the at least one passage in fluid communication with the distal end of the at least one coiled tube and at least one orifice formed in the distal end of the tip portion.

Other embodiments, aspects, and features of the invention will be apparent from the following detailed description, the accompanying drawings, and the appended claims.

### BRIEF DESCRIPTION OF THE DRAWINGS

Having thus described the embodiments of the invention in general terms, reference will now be made to the accompanying drawings, which are not necessarily drawn to scale, and wherein:

FIG. 1 is a schematic representation of an example turbine.

FIG. 2 is a schematic representation of an example conventional secondary fuel nozzle assembly.

FIG. 3 is a schematic representation of an example secondary fuel nozzle assembly, in accordance with one embodiment of the invention.

FIG. 4 is a cross section schematic representation of an example secondary fuel nozzle assembly, in accordance with one embodiment of the invention.

FIG. 5 illustrates a flowchart illustrating one example method for manufacturing an secondary fuel nozzle assembly, in accordance with one embodiment of the invention.

### DETAILED DESCRIPTION OF THE INVENTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Disclosed are systems, methods, and apparatus providing an secondary fuel nozzle assembly. According to one embodiment, a secondary fuel nozzle assembly can include at least one fuel circuit, such as a pilot fuel circuit, having a coiled tube as at least part of the fuel circuit. The coiled tube is at least slightly flexible, permitting expansion, flexing, and/or deformation when the secondary fuel nozzle assembly is exposed to extreme temperatures, thus reducing the structural strain on the secondary fuel nozzle assembly such as may occur during thermal expansion. According to one embodiment, the secondary fuel nozzle assembly includes one coiled tube as a pilot fuel circuit, whereas another passage provides the main secondary fuel circuit through the nozzle. A flange may be further included as part of the secondary fuel nozzle assembly, permitting at least one pilot fuel line to interface with the coiled tube and permitting a main secondary fuel line to interface with the other passage providing the main secondary fuel circuit.

Though, in other embodiments, multiple coiled tubes and/or multiple other fuel passages can be included, as well as a flange configured to interface with respective fuel lines, tubes, and fuel passage, providing multiple fuel circuits through the nozzle. Moreover, although the embodiments described herein are described as secondary fuel nozzle assemblies, one or more coiled tubes can be included in other fuel nozzle types.

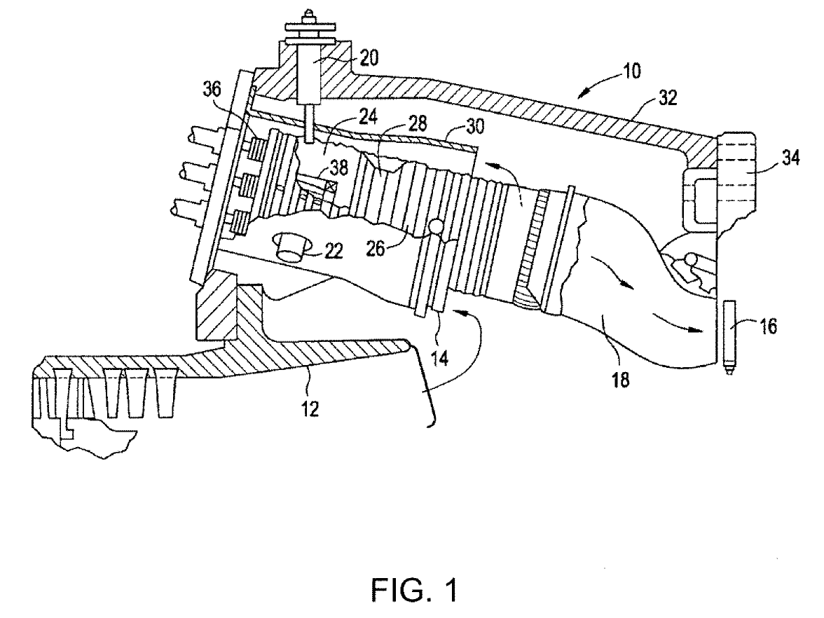

FIG. 1 is a schematic cross section representation of an example gas turbine in which one or more secondary fuel nozzle assemblies may be operative, according to one embodiment. The example gas turbine 10 (partially shown) includes a compressor 12 (partially shown), a plurality of combustors 14 (only one shown), and a turbine section represented here by a single blade 16. Although not specifically shown, the turbine is operatively connected to the compressor 12 along a common axis. The compressor 12 pressurizes inlet air which is then reverse flowed to the combustor 14 where the air is used to cool the combustor and to facilitate the combustion process.

As noted above, the plurality of combustors 14 are located in an annular array about the axis of the gas turbine. A transition duct 18 connects the outlet end of each combustor 14 with the inlet end of the turbine to deliver the hot products of combustion to the turbine in the form of an approved temperature profile.

Each combustor 14 may comprise a primary or upstream combustion chamber 24 and a secondary or downstream combustion chamber 26 separated by a venturi throat region 28. The combustor 14 is surrounded by combustor flow sleeve 30 which channels compressor discharge air flow to the combustor 14. The combustor 14 is further surrounded by an outer casing 32 which is bolted to a turbine casing 34.

Primary nozzles 36 provide fuel delivery to the upstream combustor 24 and are arranged in an annular array around a central secondary nozzle 38. Ignition is achieved in the various combustors 14 by means of sparkplug 20 in conjunction with crossfire tubes 22 (only one shown). The secondary nozzle 38 provides fuel delivery to the downstream combustion chamber 26.

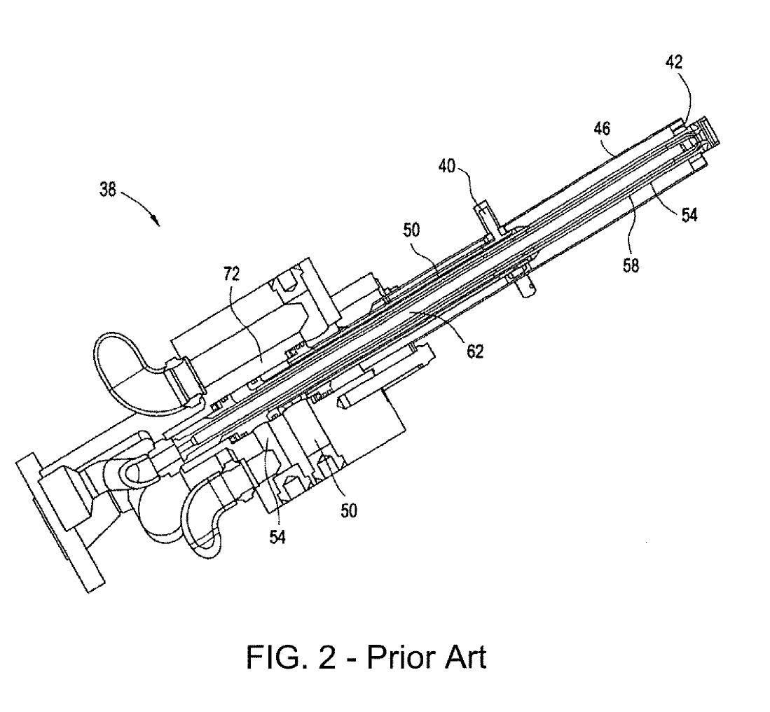

FIG. 2 is a schematic representation of a conventional secondary nozzle assembly 38 having two fuel introduction locations including secondary nozzle pegs 40 and a secondary nozzle pilot tip 42. The secondary nozzle pegs 40 provide fuel to a pre-mix reaction zone of the combustor 14, while the secondary nozzle pilot tip 42 provides fuel to the downstream combustion chamber 26 where it is immediately burned (diffusion combustion). The secondary nozzle assembly 38 thus is a combustion system fuel delivery device that includes at least one secondary main fuel delivery circuit and at least one pilot fuel delivery circuit, exiting the secondary nozzle pegs 40 and the secondary nozzle pilot tip 42, respectively. The secondary nozzle pegs 40 and the secondary nozzle pilot tip 42 each have their own independent fuel piping circuit made from concentric tubes, such as may thus define at least a pilot fuel circuit and a secondary main fuel circuit in the passages between a series of centric tubes. Various conventional secondary fuel nozzles assemblies may have one or more fuel circuits and or pilot circuits, as well as other circuits, such as for purge air, purge fluid, and the like. In the example conventional secondary fuel nozzle assembly 38 illustrated in FIG. 1, at least five passages are defined by series of centric tubes, such as is illustrated by passageways 46, 50, 54, 58, and 62. In this conventional secondary fuel nozzle assembly 38, the passages 46, 50, 54, 58, 62 may deliver multiple main fuels, pilot fuels, purge air, and/or purge fluid.

However, the construction of conventional secondary fuel nozzle assemblies constructed from multiple concentric tubing to define fuel circuit passages, such as is illustrated in FIG. 1, require many seals, such as piston ring seals, lip seals, and/or gold plated seals, which are expensive to manufacture and create a potential for failure. These conventional secondary fuel nozzle assemblies are also typically welded together to construct the fuel circuit passages, also creating a potential for failure. For example, during thermal loading of the nozzle assembly and/or during operation, the assembly components are subjected to extreme temperatures, which can weaken seals and welds, as well as cause thermal expansion in and between the concentric tubing, resulting in further structural strain on the seals and welds.

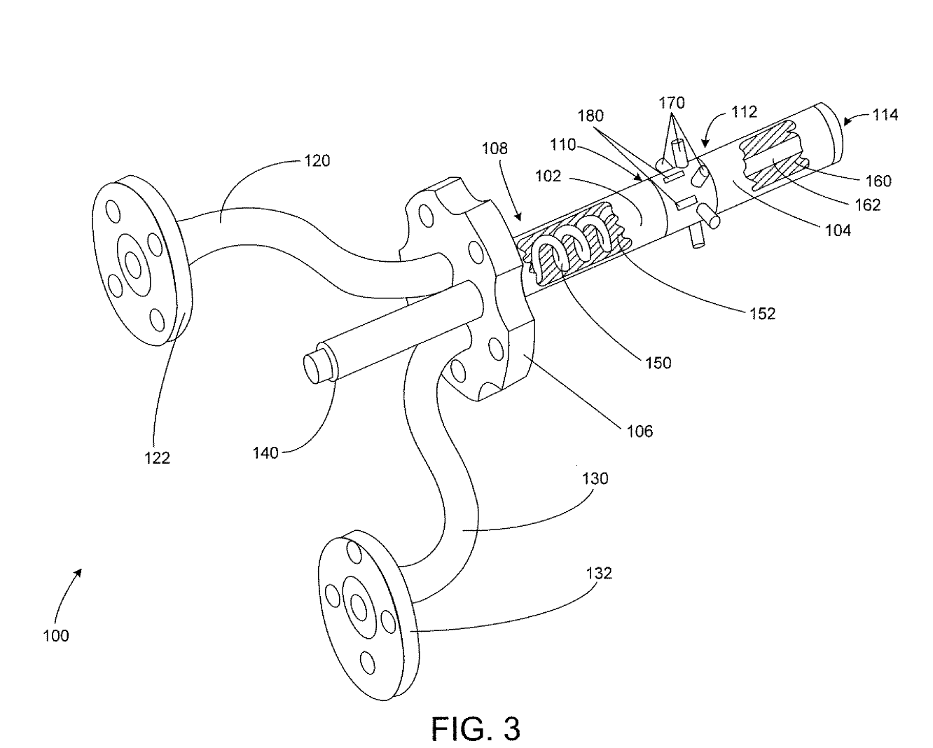

Accordingly, FIG. 3 illustrates secondary fuel nozzle assemblies that reduce the number of causes for potential failure and/or weakening, and improve the thermal expansion characteristics. FIG. 3 shows a schematic representation of a secondary fuel nozzle assembly 100 in accordance with one embodiment. The secondary fuel nozzle assembly 100 is constructed of at least a central portion 102, a tip portion 104, and a flange 106. According to this embodiment, the central portion 102 and the tip portion 104 are substantially aligned along a common axis extending longitudinally therethrough. The central portion 102 forms at least one central passage 152 and includes a proximal end 108 and a distal end 110. The flange 106 is affixed to the proximal end 108 of the central portion 102. The tip portion 104 also forms at least one tip passage 160 and includes a proximal end 112 and a distal end 114. The proximal end 112 of the tip portion 104 is affixed to or otherwise integrated with the distal end 110 of the central portion 102.

The flange 106 can further include at least one main secondary fuel line 120 in fluid communication with secondary fuel line orifice extending through the flange 106 and in communication with an interior passage of the central portion 102. According to one embodiment, the one or more main secondary fuel lines 120 can include a main secondary fuel line flange 122, including one or more orifices operable to facilitate connection with a combustor or fuel supply device. Although a main secondary fuel line flange 122 is illustrated in FIG. 3, any other means for connecting the main secondary fuel line may be employed, according to other embodiments. Moreover, although the main secondary fuel line 120 illustrated has a curved shape, any other shape as desired, which may depend at least in part on the combustor configuration and/or the fuel supply device, may be employed, according to other embodiments. Although a single main secondary fuel line 120 is illustrated and described, the secondary fuel nozzle assembly 100 may be configured to include any number of main secondary fuel lines, such as to deliver multiple fuels and/or vary delivery of fuel through multiple fuel circuits defined within the nozzle assembly, according to other embodiments.

The flange 106 can further include at least one pilot fuel line 130 in fluid communication with a pilot orifice extending through the flange 106 and in communication with a pilot tube disposed within the central portion 102. Similar to the main secondary fuel line 120, the pilot fuel line 130 can optionally include a pilot fuel line flange 132, which may include one or more orifices for connecting to a combustor and/or pilot fuel supply device. According to various embodiments, the pilot fuel line 130 may be formed in any shape, as may depend upon the combustor and/or pilot fuel supply configuration. In addition, according to other embodiments of the invention, the secondary fuel nozzle assembly 100 may be configured to include any number of pilot fuel lines in fluid communication with any number of pilot tubes disposed within the central portion 102. Accordingly, the secondary fuel nozzle assembly 100 permits one or more pilot fuel lines 130 and associated coiled tubes to be simply and efficiently incorporated without requiring various expensive and failure prone seals, such as one or more slip ring piston seals, according to various embodiments.

According to one embodiment, a flame detector 140 may also be affixed or otherwise integrated with the flange and in communication with a flame detector passage extending through the central portion 102 and the tip portion 104.

The central portion 102 of the secondary fuel nozzle assembly 100 is illustrated in FIG. 3 with a partial cutaway showing the central passage 152 and its contents. The central portion 102 can include at least one pilot tube, which is configured as a coiled tube 150 having a substantially coiled or helical shape. The coiled tube 150, disposed within a central passage 152 of the central portion 102 from its proximal end 108 to its distal end 110, is affixed to the flange 106 and in fluid communication with the pilot orifice. According to one embodiment, the coiled tube can be welded to the flange 106 though other techniques can be used.

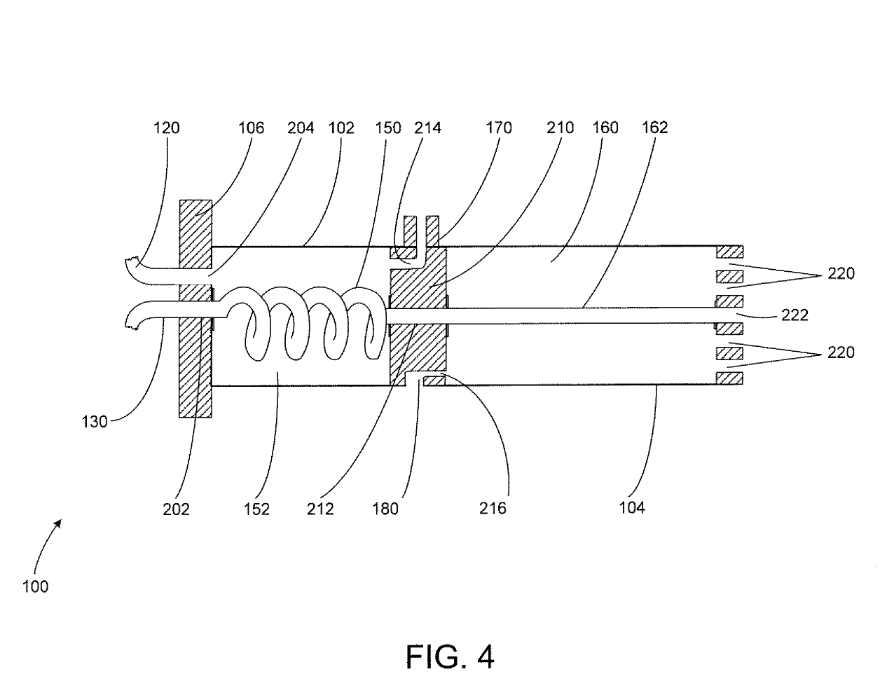

The tip portion 104 of the secondary fuel nozzle assembly 100 is also illustrated in FIG. 3 with a partial cutaway showing the tip passage 160 and its contents. The tip portion 104 may optionally include a manifold disposed within its proximal end 112 and extending at least partially across the tip passage, as further illustrated and described with reference to FIG. 4. According to one embodiment, the coiled tube 150 may be welded or otherwise affixed to the manifold. According to one embodiment, the coiled tube 150 at its distal end is in communication with at least one orifice through the manifold, such that the coiled tube 150 is in fluid communication with at least one passage extending through the tip portion 104 and out its distal end 114. In one example, a tip tube 162 is disposed within the tip passage 160 and in communication with the orifice extending through the manifold, thus in communication with the coiled tube 150. At the distal end 114 of the tip portion 104, the tip tube 162 is in communication with one or more orifices extending through the end of the tip portion 114 and into the surrounding environment (e.g., the combustor). In other embodiments, the pilot fuel may be delivered directly through the tip passage 160 or through any other passage as may be disposed within the tip portion 104.

Moreover, according to one embodiment, the tip portion 104 can include multiple pegs 170 positioned circumferentially around the tip portion 104 and extending radially. Each of the pegs 170 can include an orifice in communication with one or more passages extending through the secondary fuel nozzle assembly 100, permitting the injection and mixing of fuel with air in the periphery around the secondary fuel nozzle assembly 100. For example, the main secondary fuel line 120 can feed fuel through the main secondary fuel orifice in the flange 106, into the central passage 152, and through one or more pegs 170 in fluid communication with the central passage 152. In other embodiments, however, one or more passages, such as concentric tubes, may be formed within the secondary fuel nozzle assembly 100, creating a fuel circuit between one or more fuel lines and one or more pegs 170. In yet other embodiments, such as an embodiment configured with multiple coiled tubes 150, at least one of the coiled tubes can be in fluid communication with at least one peg 170, creating a fuel circuit between a fuel line, through the coiled tube, and into one or more pegs 170 for dispersion and mixing in the periphery surrounding the secondary fuel nozzle assembly 100.

According to one embodiment, the tip portion 104 may include one or more purge air slots 180 extending through the tip portion 104 at or near its proximal end 112. The purge air slots 180 permit air to flow from the exterior of the secondary fuel nozzle assembly 100 and into its one or more passages for cooling and/or purging. In various embodiments, the air may be referred to as purge air, and is used to cool the components of the secondary fuel nozzle assembly 100 and/or purge debris, oil, gas contaminate, and the like, from its passages. In one embodiment, the purge air slots 180 open into the tip passage 160, permitting purge air to flow through the tip passage and out one or more orifices in the end of the tip portion 104. In other embodiments, however, the purge air slots 180 can be positioned at other areas of the secondary fuel nozzle assembly 100, such as along the central portion 102 and/or at other positions along the tip portion 104, and may be in communication with one or more passages for cooling and/or purging of those passages.

According to one embodiment, purge air and/or fluid can be delivered through the central portion 102, such as through the central passage 252, and may exit via one or more pegs 170 and/or through passages in the tip portion 104.

Accordingly, a secondary fuel nozzle assembly 100 configured as described with reference to FIG. 3 provides a fuel nozzle assembly having at least one coiled tubing 150 as at least part of at least one fuel circuit. In use, a pilot fuel can be delivered through the pilot fuel line 130, into the coiled tube 150 disposed in the central portion 102, through the manifold in the tip portion 104, through the tip tube 162, and out into the periphery through the end of the tip portion 104. Thus, a pilot can be maintained through this fuel circuit consisting of the coiled tube 150. Similarly, main secondary fuel can be delivered through the main secondary fuel line 120, into the central passage 152, and at least partially out of the pegs 170 for mixing in the periphery.

Utilizing a coiled tube 150 as a passage for fuel, such as pilot fuel, permits the coiled tube 150 to expand, flex, or otherwise change shape when exposed to extreme temperatures, reducing the structural stress that would otherwise be placed on conventional passages constructed from a series of concentric tubes, as described with reference to FIG. 2. Accordingly, the coiled tube 150 effectively reduces yielding or other structural deficiencies otherwise caused by thermal expansion.

A secondary fuel nozzle assembly 100 configured in this manner—with a single pilot circuit and a single secondary fuel circuit—can operate as a transferless secondary fuel nozzle. However, according to other embodiments, additional fuel circuits may be added by including multiple fuel lines in communication with multiple coiled tubes 150 extending through the central passage 152 of the central portion 102, permitting coordinated delivery of different fuels, different flow rates, and the like, operable as a transfer fuel nozzle.

FIG. 4 is a cross section view of the example secondary fuel nozzle assembly 100, such as is described with reference to FIG. 3. As illustrated, the secondary fuel nozzle assembly 100 includes a central portion 102 defining a central passage 152, within which at least one coiled tube 150 is disposed, oriented longitudinally approximately along a central axis running through the central portion 102. The pilot fuel orifice 202 is also shown extending through the flange 106, with which the coiled tube 150 is substantially aligned, permitting a pilot fuel line 130 to be in fluid communication with the coiled tube 150. Also shown is the main secondary fuel orifice 204, permitting a main secondary fuel line 120 to be in fluid communication with the central passage 152. In other embodiments, one or more additional passages, such as may be defined by tubes, concentric tubes, coiled tubes, and the like, may be disposed within the central passage 152 and in fluid communication with one or more main secondary fuel lines 120 creating separate fuel circuits through the central passage 152.

This cross section view also illustrates the manifold 210 positioned within the proximal end 112 of the tip portion 104. According to one embodiment, the manifold 210 contains a manifold pilot orifice 212, with which the coiled tube 150 and the tip tube 162 are substantially aligned, permitting the coiled tube 150 to be in fluid communication with the tip tube 162. In other embodiments, however, multiple tip tubes 162 and/or other separate passages may be disposed within the tip passage 160 and in communication with one or more orifices formed within the manifold 210.

The cross section view of the manifold 210 also illustrates at least one peg orifice 214 passing through a peg 170 and the manifold 210 in fluid communication with the central passage 152. Similarly, at least one purge air orifice 216 is illustrated passing through the body of the manifold 210 from the purge air slot 180 into the tip passage 160. While only one peg orifice 214 and one purge air orifice 216 are shown, it is appreciated that multiple peg orifices 214 and multiple purge air orifices 216 can be formed through the manifold 210 and in communication with multiple pegs 170 and multiple purge air slots 180 positioned circumferentially around the tip portion 104, respectively.

Also illustrated in the cross section view of FIG. 4 is the distal end 114 of the tip portion 104, which can contain multiple tip orifices 220 and at least one tip pilot orifice 222 extending therethrough and communicating with the exterior, according to one embodiment. In one example embodiment, the multiple tip orifices 220 permit purge air and/or fluid passing through the purge air slots 180 into the tip passage 160 to exit into the periphery surrounding the tip portion of the secondary fuel nozzle assembly 100. Also in one example, the tip pilot orifice 222 is in fluid communication with the tip tube 162, permitting pilot fuel passing from the coiled tube 150 into the tip tube 162 to also exit into the surrounding environment. According to other embodiments, multiple passages may be formed and disposed within the tip portion 104, each exiting through one or more orifices formed through the distal end 114 and into the surrounding periphery, including passages for purge air, cooling fluid, and/or fuel.

Accordingly, as illustrated in the example embodiment of FIG. 4, a pilot fuel can be delivered from the pilot fuel line 130, through the pilot orifice 202, into the coiled tube 150, through the manifold pilot orifice 212, through the tip tube 162, and out into the periphery through the end of the tip portion 104 via the tip pilot orifice 222. Similarly, a main secondary fuel can be delivered from the main secondary fuel line 120, through the main secondary fuel orifice 204, into the central passage 152, and out of multiple pegs 170 via the peg orifices 214 for mixing in the periphery. In other embodiments, however, different and/or additional fuel circuits may be formed or otherwise provided for within the central portion 102 and/or the tip portion 104.

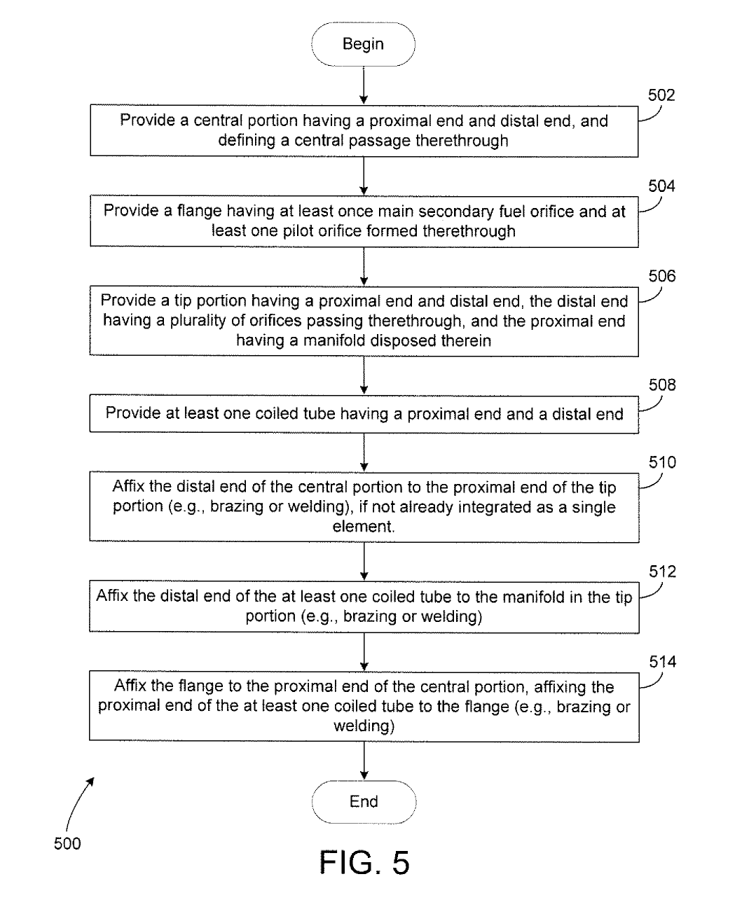

FIG. 5 is a flowchart of an example method 500 of manufacturing a secondary fuel nozzle assembly, according to one embodiment. According to various embodiments, one or more of the components of a secondary fuel nozzle assembly can be constructed from any suitable material, such as metals having properties able to withstand extreme temperatures like stainless steel, for example. In construction, one or more of the components may formed by gun drilling or machining stock to form one or more of the passages or orifices described above, according to various embodiments. Gun drilling and/or machining reduces the number of seals and welding required, creating a stronger, more cost efficient nozzle assembly constructed using simpler manufacturing techniques than conventional fuel nozzles. Moreover, affixing one or more of the components can be achieved by welding and/or brazing, thereby creating unitary components having increased strength. Thus, a secondary fuel nozzle assembly manufactured in this manner may ultimately be lighter than conventional secondary fuel nozzles, such as may result from thinner components, such as thinner flanges fewer components, less seals, and the like. Lighter weight secondary fuel nozzle assemblies can be easier to handle and maneuver, reducing shipping costs and simplifying installation.

According to various embodiments, the costs associated with manufacturing a secondary fuel nozzle assembly, as described herein, can be commensurate or less than conventional, simple construction transferless secondary fuel nozzle assemblies, while having improved strength and reliability. Moreover, removing or otherwise limiting the number of seals, welds, and joints reduces the likelihood of failure that such connection points often cause. For example, for example removing slip seal joints can often accumulate debris, become scratched, which may ultimately lead to leaking fuel into the wrong pathway, causing burning, melting, and/or erosion. Moreover, seals, such as slip seal joints, can be very costly to replace.

The method 500 begins at block 502, in which a central portion for a fuel nozzle is provided. As described above with respect to FIG. 3, the central portion of a fuel nozzle has a proximal end and distal end, and defines a central passage therethrough.

Following block 502 is block 504, in which a flange is provided. As described above with respect to FIG. 3, the flange can have at least one main secondary fuel orifice and at least one pilot orifice formed therethrough. The main secondary fuel orifice can be in communication or otherwise permit affixing a main secondary fuel line as described above and operable to integrate with a combustor. Similarly, the pilot orifice can also be in communication with or otherwise permit affixing a pilot fuel line. In various other embodiments, multiple fuel lines can be included, for which additional orifices can be formed through the flange and in fluid communication with one or more additional passages through the central portion and optionally the tip portion, as desired. According to one embodiment, the flange can be manufactured from stock having a substantially thinner cross section than conventional fuel nozzle flanges, such as up to approximately one-eighth of the cross section thickness of a conventional flange. Minimizing the flange thickness can reduce overall weight of the secondary fuel nozzle assembly.

Following block 504 is block 506, in which a tip portion is provided. As described above with respect to FIG. 3, the tip portion has a proximal end and distal end. According to one embodiment, the distal end can include a plurality of orifices formed therethrough, and the proximal end can include a manifold disposed therein, such as at or near the proximal end of the tip portion. The manifold may be formed by gun drilling and/or machining one or more orifices, such as peg orifices, purge air orifices, and/or manifold pilot orifices, according to one embodiment as described above. Also according to one embodiment, the manifold may be affixed within the tip portion by brazing and/or welding. In other embodiments, the manifold may be positioned at other positions within another passage, such as within the central passage at its distal portion, or at another position within the tip passage.

Following block 506 is block 508, in at least one coiled tube having a proximal end and a distal end is provided. According to one embodiment, such as with respect to FIG. 3, the coiled tube can be constructed from a metal able to withstand high temperatures, but able to flex under thermal expansion, reducing undesired structural strain on other components, such as at welds between concentric pipes (as occurs in conventional secondary fuel nozzle assemblies).

Following block 508 is block 510, in which the distal end of the central portion to the proximal end of the tip portion. In one embodiment, such as with respect to FIG. 3, the central portion can be affixed to the tip portion by brazing. Though in other embodiments, other techniques, such as welding, may be used.

Moreover, although a central portion and a tip portion are described as being constructed from two separate components, in other embodiments, the central portion and the tip portion may simply refer to different areas of a single component, such as constructed from a single tube. For example, a single tube may form both the central portion and the tip portion, and the manifold can be disposed at an approximate intermediate position therein. In yet another embodiment, the manifold may also be formed from the single component, such as by gun drilling or otherwise forming the central passage, tip passage, and all orifices described herein, from a single stock element. Or in other embodiments, the manifold and the tip portion, or the manifold and the central portion, may similarly be formed from a single component.

Following block 510 is block 512, in which the distal end of the coiled tube is affixed to the manifold in the tip portion. According to one embodiment, such as with respect to FIG. 3, the coiled tube may be welded to the manifold. Though in other embodiments, other techniques can be used. While affixing, the coiled tube should substantially align with at least one orifice formed through the manifold, such as the manifold pilot orifice described above.

Following block 512 is block 514, in which the flange is affixed to the proximal end of the central portion. In one embodiment, such as with respect to FIG. 3, when affixing the flange to the central portion, the proximal end of the coiled tube should also be affixed to the flange, aligning the coiled tube with at least one orifice formed through the manifold, such as the pilot orifice described above. According to one embodiment, the flange can be brazed to the central portion, welding the coiled tube to the flange. According to one embodiment, the at least slight flexibility of coiled tube facilitates assembly with the flange.

The method 500 can end after block 514, having constructed a secondary fuel nozzle.

Accordingly, a secondary fuel nozzle assembly including at least one coiled tube as at least part of a fuel circuit can be manufactured in this manner, according to one example embodiment. Upon manufacturing, the secondary fuel nozzle can be positioned and affixed within a combustor, such as a secondary combustor as described above. The newly manufactured secondary fuel nozzle assembly can be installed within a new combustor or retrofit within an existing combustor, such as by removing an existing secondary fuel nozzle assembly and installing the new secondary fuel nozzle assembly, Thus, according to various embodiments, the dimensions and configuration of the secondary fuel nozzle assembly can vary, such as the length of the central portion (adjusting the dispersion of fuel for mixing), the length of the tip portion (adjusting the exit of the purge air/fluid and/or pilot fuel), the flange, the fuel lines, and the like, depending upon the combustor design into which the assembly is to be installed.

In addition, while the method 500 is described as constructing an entire secondary fuel nozzle assembly, according to another embodiment, an existing secondary fuel nozzle assembly can be retrofit with one or more of the components described herein. For example, a conventional secondary fuel nozzle can be retrofit with at least one coiled tube by removing one or more existing passages and welding in a coiled tube and new flange configured to mate with the retrofit coiled tube, such as described with reference to blocks 512 and 514. One or more of the other components, such as a manifold, tip portion, and the like, can also be retrofit to existing secondary fuel nozzles,

While the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims.

This written description uses examples to disclose the invention, including the best mode, and also to enable persons to practice the invention, including making and using any devices or systems and performing any incorporated methods. The patentable scope the invention is defined in the claims, and may include other examples. Such other examples are intended to be within the scope of the claims if they have structural elements that do not differ from the literal language of the claims, or if they include equivalent structural elements with insubstantial differences from the literal languages of the claims.

The claimed invention is:

1. A secondary fuel nozzle assembly, comprising:
a central portion comprising a proximal end and distal end, and defining a central passage therethrough, and comprising at least one coiled tube extending through the central passage from the proximal end to the distal end;
a flange comprising at least one main secondary fuel orifice in fluid communication with the central passage at the proximal end and at least one pilot orifice in fluid communication with the at least one coiled tube at the proximal end; and
a tip portion comprising a proximal end and distal end, and defining at least one passage therethrough, the at least one passage in fluid communication with the distal end of the at least one coiled tube and at least one orifice formed in the distal end of the tip portion.

2. The secondary fuel nozzle of claim 1, further comprising at least one pilot fuel line in fluid communication with the at least one pilot orifice of the flange.

3. The secondary fuel nozzle of claim 1, wherein the proximal end of the at least one coiled tube is connected to the flange, substantially aligned with at least one pilot orifice formed therethrough.

4. The secondary fuel nozzle of claim 1, wherein the at least one coiled tube is at least partially flexible during thermal expansion.

5. The secondary fuel nozzle of claim 1, wherein the at least one coiled tube comprises a plurality of coiled tubes extending through the central passage from the proximal end to the distal end, and wherein the at least one pilot orifice comprises a plurality of pilot orifices each in fluid communication one of the plurality of coiled tubes.

6. The secondary fuel nozzle of claim 1, further comprising at least one main secondary fuel feed line in fluid communication with the at least one main secondary fuel orifice of the flange.

7. The secondary fuel nozzle of claim 1, further comprising a manifold disposed within the proximal end of the tip portion, wherein the distal end of the at least one coiled tube is affixed to the manifold, substantially aligned with at least one manifold pilot orifice formed therethrough.

8. The secondary fuel nozzle of claim 7, wherein the distal end of the at least one coiled tube is connected to the manifold, substantially aligned with at least one manifold pilot orifice formed therethrough.

9. The secondary fuel nozzle of claim 1, wherein the tip portion further comprises a plurality of pegs positioned circumferentially around the tip portion and extending radially, the plurality of pegs having orifices defined therethrough and in fluid communication with the central passage.

10. The secondary fuel nozzle of claim 1, further comprising a manifold disposed within the proximal end of the tip portion, wherein the tip portion further comprises a plurality of pegs positioned circumferentially around the tip portion and extending radially, the plurality of pegs having orifices defined therethrough, the manifold having a plurality of peg orifices defined therethrough, each in communication with one of the orifices in the plurality of pegs and in fluid communication with the central passage.

11. The secondary fuel nozzle of claim 10, further comprising at least one main secondary fuel line in fluid communication with the plurality of peg orifices, and operable to deliver a main secondary fuel through the central passage, through the plurality of peg orifices, and through the orifices in the plurality of pegs into a periphery surrounding the plurality of pegs.

12. The secondary fuel nozzle of claim 1, further comprising at least one pilot fuel line in fluid communication with the coiled tube, and operable to deliver a pilot fuel through the coiled tube, through the at least one passage formed in the tip portion, and through the at least one orifice in the distal end of the tip portion into a periphery surrounding the tip portion.

13. The secondary fuel nozzle of claim 1, wherein at least one of the central portion, the tip portion, or the flange are integrated into a one-piece assembly by being at least one of brazed or welded together.

14. A gas turbine with a combustion chamber, comprising:
at least one fuel nozzle operable to introduce fuel into the combustion chamber, the at least one fuel nozzle comprising:
a central portion comprising a proximal end and distal end, and defining a central passage therethrough, and comprising at least one coiled tube extending through the central passage from the proximal end to the distal end;
a flange comprising at least one main secondary fuel orifice in fluid communication with the central passage at the proximal end and at least one pilot orifice in fluid communication with the at least one coiled tube at the proximal end; and
a tip portion comprising a proximal end and distal end, and defining at least one passage therethrough, the at least one passage in fluid communication with the distal end of the at least one coiled tube and at least one orifice formed in the distal end of the tip portion.

15. The gas turbine of claim 14, wherein the at least one fuel nozzle comprises at least one secondary fuel nozzle.

16. The gas turbine of claim 14, wherein the at least one fuel nozzle further comprises at least one pilot fuel line in fluid communication with the at least one pilot orifice of the flange.

17. The gas turbine of claim 14, wherein the proximal end of the at least one coiled tube is connected to the flange, substantially aligned with at least one pilot orifice formed therethrough.

18. The gas turbine of claim 14, wherein the at least one coiled tube is at least partially flexible during thermal expansion.

19. The gas turbine of claim 14, further comprising at least one main secondary fuel line in fluid communication with the plurality of peg orifices, and operable to deliver a main secondary fuel through the central passage, through the plurality of peg orifices, and through the orifices in the plurality of pegs into the combustion chamber surrounding the plurality of pegs.

20. The gas turbine of claim 14, further comprising at least one pilot fuel line in fluid communication with the coiled tube, and operable to deliver a pilot fuel through the coiled tube, through the at least one passage formed in the tip portion, and through the at least one orifice in the distal end of the tip portion into the combustion chamber surrounding the tip portion.
